(19) United States
(12) Patent Application Publication
(10) Pub. No.: US 2006/0048353 A1
(43) Pub. Date: Mar. 9, 2006

(54) Horizontal casket memorabilia shelf

(76) Inventor: Larry Alan Brinneman, Florence, KY (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/156,819

(22) Filed: Jun. 20, 2005

Related U.S. Application Data
(60) Provisional application No. 60/581,243, filed on Jun. 18, 2004.

(51) Int. Cl. A61G 17/00

(52) U.S. Cl. 27/2

(57) ABSTRACT

A horizontal casket memorabilia shelf is disclosed. The horizontal casket memorabilia shelf includes a horizontal surface, removably disposed on the apex of a curved casket foot panel, for displaying personal memorabilia of the deceased, at least one support for maintaining the horizontal surface's position on the apex of the curved casket as personal memorabilia is situated, and a tubular support that interchangeably accepts objects such as miniature flagpoles, hat racks, and coat trees/valets.

### CROSS-REFERENCE TO RELATED APPLIATIONS

This application claims benefit to provisional application 60/581,243, filed on Jun. 18, 2004, entitled “Horizontal Casket Memorabilia Shelf,” which is incorporated by reference herein in its entirety.

### FIELD OF THE INVENTION

The present invention relates to an apparatus for memorializing a deceased individual, and in particular providing a place on a casket for the placement of memorabilia.

### BACKGROUND OF THE INVENTION

Upon the death of a loved one, it is common for the surviving family members to memorialize the life of the deceased by displaying pictures and objects from the deceased's life. Recently, many funeral homes and directors have made the transformation of the funeral into a so-called “life celebration”. The transformation has been accompanied by the inclusion of memorabilia, photos and sentimental objects from the person's life.

The shape and design of most caskets make displaying these objects on the casket extremely difficult. Little prior art has been dedicated to providing systems for providing places on a casket for memorializing a deceased's life.

A number of patents have issued on inventions related to funeral displays, flowers, biers, etc. U.S. Pat. No. 6,715,190 discloses a memorialization casket of the type which allows it to be personalized to the deceased comprises a shell, a lid closable upon the shell and an alcove structure mounted to an under side of the lid, the alcove structure including a recessed area adapted to receive an ornament for display. The casket lid may include a dish mounted to the under side of the casket lid, with the alcove structure being mounted to the dish. The dish may have a panel which may include an opening therethrough, with the alcove structure mounted in the opening of the dish panel. An alcove structure mounting adaptor may be mounted in the dish panel opening, with the alcove structure being mounted in the dish panel opening, with the alcove structure being mounted to the adaptor. The mounting adaptor may include a fastener fastening the alcove structure to the mounting adaptor. The alcove structure may include a fastener adapted to removably retain the ornament in the alcove structure.

U.S. Pat. No. 6,691,385 is discloses a casket corner piece display pedestal and associated methods for memorializing a deceased individual. The casket corner piece display pedestal has a center piece having first and second ends with a casket corner piece receiving surface disposed there between. The center piece includes either a memorabilia receiving container, a cremation urn, or both disposed within the first end of the center piece. A base member is attached to the second end of the center piece for supporting the casket corner piece display pedestal. The base member includes an extended portion protruding transversely to the casket corner piece receiving surface on the center piece. A cover member is removably disposed on the first end of the center piece to cover the memorabilia receiving container and/or cremation urn. The cover member includes an extended portion protruding transversely to the casket corner piece receiving surface on the center piece such that the casket corner piece display pedestal has an approximate C-shaped profile. The casket corner piece receiving surface is adapted to receive and hold a casket corner piece so that the casket corner piece can be displayed for viewing.

U.S. Pat. No. 6,467,635 discloses a portable display apparatus of the invention is used to display caskets, urns, burial vaults and related materials. The portable casket display apparatus is made from a number of extrusions which have channels along the extrusion exterior. The display apparatus has a pair of vertical back extrusions releasably connected to the first and second horizontal rear extrusions in a spaced apart relationship. Upper and lower pairs of lateral extrusions releasably connect to the vertical back extrusion in a spaced apart relationship. A sliding mechanism attaches to each lower lateral extrusion in a chancel to move a bottom casket support from beneath the upper casket support.

U.S. Pat. No. 5,727,291 discloses an integral memorabilia compartment for the placement, display and storage therein of personal effects and mementos of memorialization of the deceased. In one form the casket comprises a shell, a cap pivoted to the shell, and an openable and closable memorabilia compartment forming a part of the cap. In a another form the casket comprises a shell, a cap pivoted to the shell, and an openable and closable memorabilia compartment forming a part of the shell. In both forms the memorabilia compartment is so positioned and configured as to provide convenient access to mourners paying respects to the deceased for placing personal effects and mementos therein and to provide display of the personal effects and mementos placed therein for viewing by the mourners.

While there have been a number of casket display systems, most are complex or require modification of the casket. There is a need however, for a removable surface that can be placed on the foot panel of a casket for the display of memorabilia.

### OBJECTS AND SUMMARY OF THE INVENTION

It is an object of the present invention to provide a level surface on the foot panel of a casket for the display of personal memorabilia.

It is a further object of the present invention to provide a mount on the top of a casket for the display of personal memorabilia requiring a pole, rack or valet.

In accordance with a first aspect of the prevent invention, a novel horizontal casket memorabilia shelf is disclosed. The novel horizontal casket memorabilia shelf includes a horizontal surface, removably disposed on the apex of a curved casket foot panel, for displaying personal memorabilia of the deceased, and at least one support for maintaining the horizontal surface's position on the apex of the curved casket as personal memorabilia is situated.

In accordance with another aspect of the present invention, a novel horizontal casket memorabilia shelf is disclosed. The novel horizontal casket memorabilia shelf includes a horizontal square surface, removably disposed on the apex of a curved casket foot panel, for displaying personal memorabilia of the deceased, four adjustable supports, extending from the corners of said horizontal square surface to the surface of a curved casket foot panel, to maintaining the horizontal surface's position on the apex of curved caskets of different shapes as personal memorabilia is situated, and a tubular support that interchangeably accepts objects such as miniature flagpoles, hat racks, and coat trees/valets.

In accordance with yet another aspect of the present invention, a novel horizontal casket memorabilia shelf is disclosed. The novel horizontal casket memorabilia shelf includes an acrylic horizontal surface removably disposed on the apex of a curved casket foot panel, for displaying personal memorabilia of the deceased, having a first perpendicular bend at two opposing sides, forming supports with a length sufficient to allow said horizontal surface to rest upon the apex of said casket's foot panel. The horizontal surface additionally includes a second perpendicular bend, past said first perpendicular bend, forming an additional horizontal surface for placement of further items, and a third perpendicular bend, slightly past said second perpendicular bend, forming a small lip to prevent items from sliding of said horizontal surfaces. Finally, the novel horizontal casket memorabilia shelf includes a tubular support integrated into said second perpendicular bend that accepts a miniature flagpole and flag.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is an isometric view of a horizontal casket memorabilia shelf.

FIG. 2 is a cross sectional view of the horizontal casket memorabilia shelf of FIG. 1.

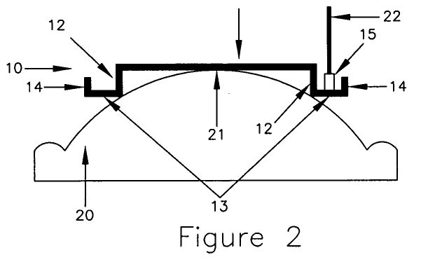

### DETAILED DESCRIPTION OF THE PREFERRED EMBODIMENT

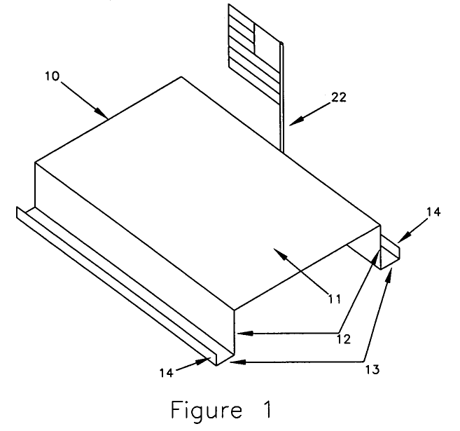

Referring now to the drawings wherein like reference numerals refer to the same components across the several views, and in particular to FIG. 1, there is shown a horizontal casket memorabilia shelf 10. In a most preferred embodiment, the horizontal casket memorabilia shelf 10 includes a horizontal surface 11, removably disposed on the apex of a curved casket foot panel 20, for displaying personal memorabilia of the deceased. The shelf may be constructed from a wide variety of materials including composite materials, glass, metals, plastics, and wood.

In the preferred embodiment, the horizontal surface 11 includes a first perpendicular bend at two opposing sides 12, forming supports with a length sufficient to allow the horizontal surface 11 to rest upon the apex 21 of said casket's foot panel. The horizontal surface can hold a wide variety of items. The horizontal surface 11 further includes a second perpendicular bend 13, past said first perpendicular bend 12, forming an additional horizontal surface for placement of further items. The horizontal surface 11 yet further includes a third perpendicular bend 14, slightly past said second perpendicular bend 13, forming a small lip to prevent items for sliding of said horizontal surfaces. This small lip also provides a surface for mounting hooks and hangers.

In an alternate embodiment, the horizontal surface 11 may be supported by one or more supports extending form said horizontal surface 11 may be formed with a concave base, which marries the convex curve of various casket lids. In either embodiment and the preferred embodiment, the supports could be adjustable, to allow the horizontal casket memorabilia shelf 10 to fit a wide range of caskets.

The horizontal casket memorabilia shelf 10 further includes a tubular support 15 integrated into said second perpendicular bend 13 that accepts a miniature flagpole and flag 22. Alternatively, the tubular support 15 holds a valet for holding a uniform, bedecked with medals, epaulettes and the like or a flag or pennant. In alternative embodiments, the tubular support 15 could be integrated into the horizontal surface 11.

While the preferred embodiments of the present invention have been described and illustrated, modifications may be made by one of ordinary skill in the art without departing from the scope and spirit of the invention as defined in the appended claims.

1. A horizontal casket memorabilia shelf, comprising:
a horizontal surface, removably disposed on the apex of a curved casket foot panel, for displaying personal memorabilia of the deceased; and at least one support for maintaining the horizontal surface's position on the apex of the curved casket as personal memorabilia is situated.

2. The horizontal casket memorabilia shelf of claim 1, wherein said at least one support for maintaining the surface's position is comprised of a curved bevel in the base of said horizontal surface, matching the curve of said casket's foot panel.

3. The horizontal casket memorabilia shelf of claim 1, wherein said at least one support for maintaining the surface's position is comprised of one integrated leg extending from said horizontal surface to said casket's foot panel, with a length sufficient to allow said horizontal surface to rest upon the apex of said casket's foot panel.

4. The horizontal casket memorabilia shelf of claim 1, wherein said at least one support for maintaining the surface's position is comprised of a bend on each of said horizontal surface's two opposing sides, forming supports with a length sufficient to allow said horizontal surface to rest upon the apex of said casket's foot panel.

5. The horizontal casket memorabilia shelf of claim 1, wherein said horizontal surface and at least one support are constructed from a material chosen from a group including composite materials, glass, metals, plastics and wood.

6. A horizontal casket memorabilia shelf, comprising:
a horizontal square surface, removably disposed on the apex of a curved casket foot panel, for displaying personal memorabilia of the deceased; four adjustable supports, extending from the corners of said horizontal square surface to the surface of a curved casket foot panel, to maintaining the horizontal surface's position on the apex of curved caskets of different shapes as personal memorabilia is situated; and
a tubular support that interchangeably accepts objects such as miniature flagpoles, hat racks, and coat trees/valets.

7. The horizontal casket memorabilia shelf of claim 6, wherein said horizontal surface and four adjustable supports are constructed from a material chosen from a group including composite materials, glass, metals, plastics and wood.

8. A horizontal casket memorabilia shelf, comprising:
an acrylic horizontal surface removably disposed on the apex of a curved casket foot panel, for displaying personal memorabilia of the deceased, having a fist perpendicular bend at two opposing sides, forming supports with a length sufficient to allow said acrylic horizontal surface to rest upon the apex of said casket's foot panel.

9. The horizontal casket memorabilia shelf of claim 6, wherein said
acrylic horizontal surface further comprising a second perpendicular bend, past said first perpendicular bent, forming an additional horizontal surface for placement of further items.

10. The horizontal casket memorabilia shelf of claim 7, wherein said acrylic horizontal surface further comprising a third perpendicular bend, slightly past said second perpendicular bend, forming a small lip to prevent items from sliding off said horizontal surfaces and to provide a surface to attach hangers and hooks for further memorabilia.

11. The horizontal casket memorabilia shelf of claim 8, further comprising a tubular support integrated into said second perpendicular bend that accepts a miniature flagpole and flag.
